(19) United States
(12) Patent Application Publication
(10) Pub. No.: US 2005/0208269 A1
(43) Pub. Date: Sep. 22, 2005

(54) Sheet extrudates with self-cleaning properties, and method for producing these extrudates of this type

(75) Inventors: Edwin Nun, Billerbeck (DE); Markus Oles, Hattingen (DE); Bernhard Schleich, Recklinghausen (DE); Gernot Dambacher, Shanghai (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/506,994

(22) PCT Filed: Feb. 5, 2003
(86) PCT No.: PCT/EP03/01113

§ 371 Date: Jun. 6, 2005

(30) Foreign Application Priority Data
Mar. 12, 2002 (DE) 102 10 674.6

(51) Int. Cl. B32B 1/00

(52) U.S. Cl. 428/143; 264/271.1; 264/280

(57) ABSTRACT

The invention relates to sheet extrudates with surfaces which have self-cleaning properties, and also to a simple process for producing these self-cleaning surfaces. The process of the invention is very simple, since it can make use of existing equipment. Sheet extrudates are usually smoothed by means of rolls. The process of the invention makes use of these rolls by applying microparticles to these rolls. The particles are impressed into the surface of the extrudate and thus transferred thereto during smoothing of the extrudates. The process of the invention provides access to self-cleaning surfaces which comprise particles with a fissured structure, without any need to apply an additional emboss layer or a foreign-material carrier layer to the moldings. Extrudates of the invention may have the shape of a film or sheet, for example.

The invention relates to sheet extrudates with self-cleaning properties and to a process for their production.

Various processes for treating surfaces to render these surface dirt- and water-repellent are known from the surface technology. For example, it is known that if a surface is to have good self-cleaning properties it has not only to be hydrophobic but also to have a certain roughness. A suitable combination of structure and hydrophobic properties permits even small amounts of water set in motion on the surface to entrain adherent dirt particles and clean the surface (WO 96/04123; U.S. Pat. No. 3,354,022, C. Neinhuis, W. Barthlott, Annals of botany 79, (1997), 667).

As early as 1982, A. A. Abramson in Chimia i Shisn russ. 11, 38, described, although without any recognition of self-cleaning properties, the roll-off of water droplets on hydrophobic surfaces particularly if these have structuring.

The prior art of EP 0 933 388 in relation to self-cleaning surfaces is that these self-cleaning surfaces require an aspect ratio>1 and a surface energy smaller than 20 mN/m. The aspect ratio is defined here as the quotient derived from the average height of the structure in relation to its average width. The abovementioned criteria are realized in the natural world, for example in the lotus leaf. The surface of the plant, formed from a hydrophobic waxy material, has elevations separated from one another by a few μm. To a substantial extent, water droplets come into contact only with these peaks. There are many descriptions in the literature of water-repellent surfaces of this type, an example being an article in Langmuir 2000, 16, 5754, by Masashi Miwa et al., according to which the contact angle and roll-off angle increase with an increase in the degree of structuring of artificial surfaces formed from boehmite, applied to a spin-coated layer and then calcined.

Swiss patent 268258 describes a process in which structured surfaces are produced by applying powders, such as kaolin, talc, clay, or silica gel. The powders are secured to the surface by oils and resins based on organosilicon compounds.

The use of hydrophobic materials, such as perfluorinated polymers, for producing hydrophobic surfaces is known. DE 197 15 906 A1 states that perfluorinated polymers, such as polytetrafluoroethylene, or copolymers of polytetrafluoroethylene with perfluoro alkyl vinyl ethers produce hydrophobic surfaces which have structuring and have low adhesion to snow and ice. JP 11171592 describes a water-repellent product and its production, the dirt-repellent surface being produced by applying, to the surface to be treated, a film which comprises fine particles of metal oxide and comprises the hydrolyzate of a metal alkoxide or of a metal chelate. To consolidate this film, the substrate to which the film has been applied has to be sintered at temperatures above 400° C. This process is therefore useful only for substrates which can be heated to temperatures above 400° C.

The processes usually used hitherto for producing self-cleaning surfaces are complicated and often have limited applicability. For example, embossing techniques are inflexible for application of structures to three-dimensional bodies of various shapes. There is still no suitable technology for producing flat, large-surface-area coating films. Processes in which structure-forming particles are applied to surfaces by means of a carrier—for example an adhesive—have the disadvantage that the surfaces obtained are composed of a very wide variety of combinations of materials which, for example, have different coefficients of thermal expansion, and this can lead to damage to the surface.

It was therefore an object of the present invention to provide a process for producing self-cleaning surfaces on flat, large-surface-area moldings. The method utilized here should be as simple as possible and resultant self-cleaning surfaces should be durable.

Surprisingly, it has been found that particles can be securely bonded to the surface of the sheet extrudate by applying hydrophobic, nanostructured particles to a roll used for the smoothing of sheet extrudates. If the particles used have hydrophobic properties, they can at the same time act as a release agent. To apply the particles it is preferable to use one or both of the rolls located in the immediate vicinity of the die. At this location, the polymer melt emerging from the die has not solidified sufficiently to prevent impression of the structured particles and bonding to the polymer matrix.

The present invention provides sheet extrudates with at least one surface which has self-cleaning properties wherein the surface has at least one securely anchored layer of microparticles which form elevations.

The present invention also provides a process for producing sheet extrudates of the invention with at least one surface which has self-cleaning properties and has elevations formed by microparticles, which comprises using a roll to impress microparticles into the surface of a sheet extrudate.

The present invention also provides films or sheets with a surface which has self-cleaning properties and has surface structures with elevations, the production process being the process of the invention.

The process of the invention has the advantage that to a very substantial extent use can be made of existing equipment for producing sheet extrudates. Sheet extrudates are usually smoothed by means of rolls. The process of the invention makes use of these rolls by applying microparticles to these rolls. The particles are impressed into the surface of the extrudate and thus transferred thereto during smoothing of the extrudates. This simple method gives access to sheet extrudates with self-cleaning surfaces which comprise particles with a fissured structure, without any need to apply an additional emboss layer or foreign material carrier layer to the extrudate.

If the particles are hydrophobic particles, these at the same time act as a release agent, since the powder applied to the roll prevents the material of the sheet extrudate from adhering to the roll used for smoothing.

The sheet extrudates of the invention have the advantage that structure-forming particles are not secured by a carrier material, thus avoiding any unnecessarily high number of combinations of material and the adverse properties associated therewith.

The process of the invention provides access to self-cleaning sheet extrudates in which the self-cleaning properties are not the result of additional application of material, other than the application of particles, or of any additional chemical process.

Another advantage of the process of the invention is that surfaces susceptible to scratching are not damaged by subsequent mechanical application of a carrier layer and/or of particles.

A factor which is proving very particularly advantageous is that any desired sizes of surface can be provided with self-cleaning properties on one or both sides.

In addition, impairment of the flexibility of films is less marked than on application of a carrier layer, and associated with this there is also no substantial loss of secondary product properties.

The invention will be described by way of example below, but is not restricted to these embodiments.

A feature of the sheet extrudates of the invention with at least one surface which has elevations and has self-cleaning properties is that the surface has at least one securely anchored layer of microparticles which form the elevations. The elevations present on at least some of the surface of the moldings combine with hydrophobic properties of the surfaces to ensure that these regions of the surfaces have low wettability and therefore have self-cleaning properties. The manner of obtaining the securely anchored layer of microparticles is that microparticles are applied in the form of a layer to a roll, and then this roll is used to impress and anchor the microparticles into the sheet extrudate. Particularly stable anchoring is obtained if use is made of microparticles whose surface has a fine structure, since the fine structure is to some extent filled by the extrudate melt, and many anchoring points are present once the extrudate melt has solidified/hardened. For the purposes of the present invention, a layer of microparticles is a surface accumulation of microparticles which form elevations. The layer may have been formed in such a way that the surface comprises exclusively microparticles, almost exclusively mircoparticles, or else microparticles whose separation is from 0 to 10 particle diameters, in particular from 0 to 3 particle diameters.

The surfaces of sheet extrudates with self-cleaning properties preferably have elevations with an average height of from 20 nm to 25 μm and with an average separation of from 20 nm to 25 μm, preferably with an average height of from 50 nm to 10 μm and/or with an average separation of from 50 nm to 10 μm, and very particularly preferably with an average height of from 50 nm to 4 μm and/or with an average separation of from 50 nm to 4 μm. The sheet extrudates of the invention very particularly preferably have surfaces with elevations with an average height of from 0.25 to 1 μm and with an average separation of from 0.25 to 1 μm. For the purposes of the present invention, the average separation of the elevations is the separation between the highest elevation of an elevation and the most adjacent highest elevation. If an elevation has the shape of a cone, the tip of the cone is the highest elevation of the elevation. If the elevation is a rectangular parallelepiped, the uppermost surface of the rectangular parallelepiped is the highest elevation of the elevation.

The wetting of bodies can be described via the contact angle formed by a water droplet with the surface. An angle of contact of 0 degree here means complete wetting of the surface. The static contact angle is generally measured using equipment in which the contact angle is determined optically. On smooth hydrophobic surfaces, the static contact angles measured are usually below 125°. The present moldings with self-cleaning surfaces have static contact angles which are preferably greater than 130°, with preference greater than 140°, and very particularly preferably greater than 145°. In addition, it has been found that a surface has good self-cleaning properties only when it exhibits a difference of not more than 10° between advancing and receding angle, and for this reason surfaces of the invention preferably have a difference of less than 10°, preferably less than 5°, and very particularly preferably less than 4°, between advancing and receding angle. To determine the advancing angle, a water droplet is placed on the surface by means of a cannula, and the droplet is enlarged on the surface by adding water through the cannula. During enlargement, the margin of the droplet glides over the surface, and the contact angle determined is the advancing angle. The receding angle is measured on the same droplet, but water is removed from the droplet through the cannula, and the contact angle is measured during reduction of the size of the droplet. The difference between the two angles is termed hysteresis. The smaller the difference, the smaller the interaction of the water droplet with the surface of the substrate, and therefore the better the lotus effect (the self-cleaning effect).

The surfaces of the invention with self-cleaning properties preferably have an aspect ratio greater than 0.15 for the elevations. The elevations formed by the particles themselves preferably have an aspect ratio of from 0.3 to 0.9, particularly preferably from 0.5 to 0.8. The aspect ratio is defined here as the quotient derived from the average height of the structure of the elevations in relation to its average width.

A feature of the sheet extrudates of the invention, which have self-cleaning properties and surface structures with elevations is that the surfaces are synthetic polymer surfaces into which the particles have been directly anchored, and have not been linked via carrier systems or the like.

The method of bonding or anchoring the particles to the surface is that rolls are used to impress the particles into the sheet extrudate. In order to achieve the specified aspect ratios it is advantageous for at least some of the particles, preferably more than 50% of the particles, to be impressed into the surface of the sheet extrudate to the extent of only 90% of their diameter. The surface therefore preferably comprises particles which have been anchored with from 10 to 90%, preferably from 20 to 50%, and very particularly preferably from 30 to 40%, of their average particle diameter within the surface, and which therefore still have parts of their inherently fissured surface protruding from the extrudate. This method ensures that the elevations which are formed by the particles themselves have a sufficiently large aspect ratio, preferably at least 0.15. This method also ensures that the securely bonded particles have very durable bonding to the surface of the molding. The aspect ratio is defined here as the ratio of maximum height to maximum width of the elevations. A particle assumed to be ideally spherical and protruding to an extent of 70% from the surface of the sheet extrudate has an aspect ratio of 0.7 according to this definition.

The microparticles securely bonded to the surface and forming the elevations on the surface of the sheet extrudates have preferably been selected from silicates, minerals, metal oxides, metal powders, silicas, pigments, and polymers, very particularly preferably from fumed silicas, precipitated silicas, aluminum oxide, mixed oxides, doped silicates, titanium dioxides, and pulverulent polymers.

Preferred microparticles have a diameter of from 0.02 to 100 μm, particularly preferably from 0.01 to 50 μm, and very particularly preferably from 0.1 to 30 μm. However, other suitable micro particles are those which have a diameter of less than 500 nm or which combine primary particles to give agglomerates or aggregates whose size is from 0.2 to 100 μm.

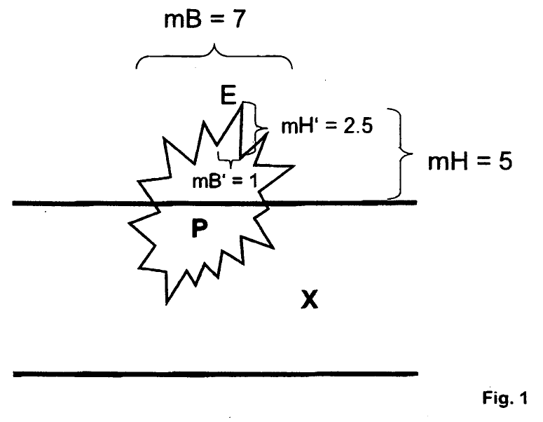

Particularly preferred microparticles which form the elevations of the structured surface are those whose surface has an irregular fine structure in the nanometer range. These microparticles having the irregular fine structure preferably have elevations/fine structures whose aspect ratio is greater than 1, particularly preferably greater than 1.5. The aspect ratio is again defined as the quotient obtained by dividing the maximum height of the elevation by its maximum width. FIG. 1 illustrates diagrammatically the difference between the elevations formed by the particles and the elevations formed by the fine structure: The figure shows the surface of a sheet extrudate X, which comprises particles P (only one particle being depicted to simplify the illustration). The elevation formed by the particle itself has an aspect ratio of about 0.71, calculated as the quotient obtained from the maximum height of the particle mH, which is 5, since only that portion of the particle which protrudes from the surface of the sheet extrudate X contributes to the elevation, and from the maximum width mB, which in turn is 7. A selected elevation of the elevations E present on the particles by virtue of the fine structure of the particles has an aspect ratio of 2.5, calculated as quotient from the maximum height of the elevation mH′, which is 2.5, and from the maximum width mB′, which in turn is 1.

Preferred microparticles whose surface has an irregular fine structure in the nanometer range are particles which comprise at least one compound selected from fumed silica, precipitated silicas, aluminum oxide, mixed oxides, doped silicates, titanium dioxides, and pulverulent polymers.

It can be advantageous for the microparticles to have hydrophobic properties, and the hydrophobic properties may be attributable to the properties of the materials themselves present on the surfaces of the particles, or else may be obtained through treatment of the particles with a suitable compound. The microparticles may be provided with hydrophobic properties prior to or after application to the surface of the sheet extrudate.

To hydrophobicize the particles prior to or after application to the surface, they may be treated with a compound suitable for hydrophobicization, e.g. from the group of the alkylsilanes, the fluoroalkylsilanes, and the disilazanes.

Highly preferred microparticles are described in more detail in the following. The particles may derive from various fields. They may be silicates, for example, or doped silicates, minerals, metal oxides, aluminum oxide, silicas, or titanium dioxides, Aerosils, or pulverulent polymers, e.g. spray-dried and agglomerated emulsions, or cryogenically milled PTFE. Particularly suitable particle systems are hydrophobized fumed silicas, known as Aerosils®. To generate the self-cleaning surfaces, hydrophobic properties are needed in addition to the structure. The particles used may themselves be hydrophobic, for example pulverulent polytetrafluoroethylene (PTFE). The particles may have been provided with hydrophobic properties, for example Aerosil VPR 411® or Aerosil R 8200®^{.} However, they may also be hydrophobicized subsequently. It is unimportant here whether the particles are hydrophobicized prior to application or after application. Examples of particles to be hydrophobized are Aeroperl 90/30®, Sipernat silica 350®, aluminum oxide C®, zirconium silicate, vanadium-doped or Aeroperl P 25/20®. In the case of the latter, the hydrophobicization advantageously takes place through treatment with perfluoroalkylsilane compounds, followed by heat-conditioning.

The sheet extrudates may have the elevations on all, in particular on two, surfaces, or only on certain surfaces. The moldings of the invention preferably have the elevations on only one of the two surfaces.

The material of the sheet extrudates themselves may preferably comprise polymers based on polycarbonates, on polyoxymethylenes, on poly(meth)acrylates, on polyamides, on polyvinyl chloride (PVC), on polyethylenes, on polypropylenes, on polystyrenes, on polyesters, on aliphatic linear or branched polyalkenes, on cyclic polyalkenes, on polyacrylonitrile, or on polyalkylene terephthalates, or else may comprise their mixtures or copolymers. The material of the sheet extrudates particularly preferably comprises a material selected from poly(vinylidene fluoride), poly(hexafluoropropylene), poly(perfluoropropylene oxide), poly(fluoroalkyl acrylate), poly(fluoroalkyl methacrylate), poly(vinyl perfluoroalkyl ether), or comprises other polymers from perfluoroalkoxy compounds, poly(ethylene), poly(propylene), poly(isobutene), poly(4-methyl-1-pentene), or polynorbornene, in the form of homo- or copolymer. The material for the surface of the sheet extrudates particularly preferably comprises poly(ethylene), poly(propylene), polycarbonate, polyesters, or poly(vinylidene fluoride). Besides the polymers, the materials may comprise the usual additives and auxiliaries, e.g. plasticizers, pigments, or fillers.

The sheet extrudates of the invention are preferably produced by the process of the invention for producing sheet extrudates with at least one surface which has self-cleaning properties and has elevations formed by microparticles, which comprises using a roll to impress microparticles into the surface of a sheet extrudate. The roll may be a roll specifically provided. However, the roll used to impress the microparticles into the surface of the melt of the sheet extrudate, where this melt has not yet solidified, is particularly preferably a roll needed for the production of conventional sheet extrudates, in particular a roll which is used for smoothing sheet extrudates and which is in any case usually already present. For applying the particles it is preferable to use one or two of the rolls located in the immediate vicinity of the die. At this location, the polymer melt emerging from the die has not yet solidified to an extent which would prevent impression of the structured particles and bonding to the polymer matrix.

The method of impression is preferably such that the extent to which the particles are impressed into the surface of the sheet extrudate is only a maximum of 90% of their diameter, preferably from 10 to 90%, with preference from 20 to 50%, and very particularly preferably from 30 to 40%, of their average diameter.

The sheet extrudate used may be any of the sheet extrudates based on polymers. Preference is given to sheet extrudates which comprise a polymer based on polycarbonates, on polyoxymethylenes, on poly(meth)acrylates, on polyamides, on polyvinyl chloride, on polyethylenes, on polypropylenes, on aliphatic linear or branched polyalkenes, on cyclic polyalkenes, on polystyrenes, on polyesters, on polyacrylonitrile, or on polyalkylene terephthalates, or on poly(vinylidene fluoride), or which comprise other polymers from poly(isobutene), poly(4-methyl-1-pentene), and polynorbornene, in the form of homo- or copolymer, or a mixture of these. Besides the polymers, the sheet extrudates may comprise the usual additives and/or auxiliaries, e.g. plasticizers, pigments, or fillers.

The microparticles which in the process of the invention are impressed into the surface of the melt of the sheet extrudate by means of a roll, where this melt has not yet hardened, may be applied, prior to impression, either to the surface of the extrudate or else to the surface of the roll used for impression. If the microparticles are applied to the sheet extrudate, application methods which may be used are spraying, scattering, or the like. The microparticles are usually in loose form on application to the sheet extrudate. It can also be advantageous for the microparticles to be applied to the roll prior to impression. The method of application may be spraying or scattering. The application of the microparticles to the roll can in particular be advantageous because the microparticle powder applied to the roll, in particular to the roll used for smoothing, prevents adhesion of the material of the sheet extrudate to the roll during smoothing (and during impression of the microparticles), since material does not usually come into contact at all with the roll, because the microparticles have been applied very densely to the roll to achieve the preferred separations of the elevations. This release effect is naturally also achieved if the microparticles are applied to the sheet extrudate. It can be advantageous to apply the microparticles both to the sheet extrudate and to the roll.

An example of a way of applying the microparticles to the roll by spraying is spray-application of microparticle powders or dispersions which comprise, besides the microparticles, a solvent, which is preferably volatile. The solvent present in the suspensions used preferably comprises an alcohol, in particular ethanol or isopropanol, ketones, e.g. acetone or methyl ethyl ketone, ethers, e.g. diisopropyl ether, or else hydrocarbons, such as cyclohexane. The suspensions very particularly preferably comprise alcohols. It can be advantageous for the suspension to comprise from 0.1 to 10% by weight, preferably from 0.25 to 7.5% by weight, and very particularly preferably from 0.5 to 5% by weight, of microparticles, based on the total weight of the suspension.

In particular for spray-application of a suspension, it can be advantageous for the roll to have a temperature of from 20 to 150° C. Depending on the sheet extrudate, however, the temperature of the roll may also be within the specified range irrespective of the microparticles or of the application of the microparticles.

The pressure which the roll exerts on the sheet extrudate in order to smooth the same and/or to press the microparticles into the surface of the sheet extrudate cannot be determined and depends on the material to be smoothed and its finish, and also on the width of the gap between the two rolls which are used to smooth the extrudate. The width of the gap between the rolls may be set as desired within wide limits.

Typical widths of the gap vary from a few micrometers as far as a number centimeters, preferably from 5 μm to 5 cm. It is often found that the depth of impression of the particles into the extrudate decreases with increasing gap width. This is probably associated with the increasing flexibility of the material as the extrudate becomes thicker. The process of the invention is therefore preferably used with sheet extrudates whose material has a thickness of from 5 μm to 500 μm. The process of the invention can also naturally produce sheets with a hollow chamber, e.g. sandwich panels. The total thickness of the material of these may be markedly more than 500 μm. In order that the smoothing rolls do not compress the hollow sheets in these processes, a superatmospheric pressure is produced in the hollow chambers, e.g by compressed air, so that compression is very substantially avoided.

It can be advantageous to use at least two rolls and to impress microparticles into the surface of the sheet extrudate on two sides of the sheet extrudate. It can be particularly advantageous for the microparticles to be impressed by one of two, or else by two, opposite rolls between which the sheet extrudate passes.

The microparticles used in the process of the invention are preferably those which comprise at least one material selected from silicates, minerals, metal oxides, metal powders, silicas, pigments, and polymers. It is preferable to use microparticles whose diameter is from 0.02 to 100 μm, particularly preferably from 0.01 to 50 μm, and very particularly preferably from 0.1 to 30 μm. It is also possible to use microparticles with diameters less than 500 nm. However, other suitable microparticles are those which combine primary particles to give agglomerates or aggregates whose size is from 0.2 to 100 μm.

Preferred microparticles used, in particular particles whose surface has an irregular fine structure in the nanometer range, are particles which comprise at least one compound selected from fumed silica, precipitated silicas, aluminum oxide, mixed oxides, doped silicates, titanium dioxides, and pulverulent polymers. Preferred particles whose surface has an irregular fine structure in the nanometer range have, by virtue of this fine structure, surface elevations which have an aspect ratio greater than 1, particularly preferably greater than 1.5, and very particularly preferably greater than 2.5. The aspect ratio is again defined as the quotient derived from the maximum height of the elevation in relation to its maximum width.

The microparticles preferably have hydrophobic properties, and these hydrophobic properties may be attributable to the properties of the materials themselves present on the surfaces of the particles, or else may be obtained through treatment of the particles with a suitable compound. The particles may be provided with hydrophobic properties prior to or after impression into the surface.

To hydrophobicize the microparticles prior to or after impression (anchoring) into the surface of the sheet extrudate, these may be treated with a compound suitable for hydrophobicization, e.g. from the group of the alkylsilanes, the fluoroalkylsilanes, and the disilazanes.

Microparticles whose use is preferred are described in more detail in the following. The particles used may derive from various fields. They may be silicates, for example, or doped silicates, minerals, metal oxides, aluminum oxide, silicas, or titanium dioxides, Aerosils®, or pulverulent polymers, e.g. spray-dried and agglomerated emulsions, or cryogenically milled PTFE. Particularly suitable particle systems are hydrophobized fumed silicas, known as Aerosils®. To generate the self-cleaning surfaces, hydrophobic properties are needed in addition to the structure. The particles used may themselves be hydrophobic, for example pulverulent polytetrafluoroethylene (PTFE). The particles may have been provided with hydrophobic properties, for example Aerosil VPR 411® or Aerosil R 8200®. However, they may also be hydrophobicized subsequently. It is unimportant here whether the particles aare hydrophobicized prior to application or after application. Examples of particles to be hydrophobized are Aeroperl 90/30®, Sipernat silica 350®, aluminum oxide C®, zirconium silicate, vanadium-doped or Aeroperl P 25/20®. In the case of the latter, the hydrophobicization advantageously takes place through treatment with perfluoroalkylsilane compounds, followed by heat-conditioning.

Examples of products which can be produced by means of the process of the invention are sheets, including sheets with hollow chambers, and films, where these have at least one surface having self-cleaning properties and having surface structures with elevations. These films or sheets may be applied to buildings, vehicles, or other articles, for example, so that these likewise have self-cleaning properties. However, the films may also be used as they stand, for example as packaging films which keep the packaged product free from moisture and dirt.

The process of the invention is described using the examples below, but there is no intention that the invention be restricted to these examples.

### EXAMPLE 1

A polyoxymethylene (Ultraform® W2320-003, BASF AG) sheet extrudate with a thickness of 5 mil (1 mil corresponding to 25 μm) is dusted on one side with hydrophobic fumed silica, Aerosil R 8200, Degussa AG, after leaving the extruder (ZDSK28, Werner & Pfleiderer). The dusted extrudate is smoothed by a roll pair located directly downstream of the dusting apparatus and adjusted to a gap width of 5 mil. The solidified extrudate obtained after treatment by the roll pair has particles impressed into the surface of the extrudate on one side of the film, more than 70% of these having been anchored with from 70 to 90% of their diameter within the surface. The roll-off angle for a water droplet is determined on the resultant extrudate surface by applying a droplet to the surface and constantly increasing the inclination of the extrudate to determine the angle at which the droplet rolls off from the surface. A roll-off angle smaller than 20° is found for a water droplet of size 40 μl.

### EXAMPLE 2

After leaving the extruder a nylon-12 (Vestamid® L1600, Degussa AG) sheet extrudate with a thickness of 5 mil is passed through a gap between two rolls which serves to smooth the extrudate (ZDSK28, Werner & Pfleiderer), the gap width being adjested to 5 mil. The upper of the two rolls is sprayed with hydrophobic fumed silica, Aerosil R 8200, Degussa AG, suspended in ethanol. The roll presses these particles into the extrudate during the smoothing procedure, where this extrudate has not yet solidified. The solidified extrudate obtained after treatment by the roll has particles impressed into the surface of the extrudate, more than 70% of these having been anchored with from 70 to 90% of their diameter within the surface. The roll-off angle for a water droplet is determined on the resultant extrudate surface by applying a droplet to the surface and constantly increasing the inclination of the extrudate to determine the angle at which the droplet rolls off from the surface. A roll-off angle smaller than 30° is found for a water droplet of size 40 μl.

As can be seen from the examples, the process of the invention can give extrudates which have self-cleaning or water-repellent surfaces, and it is of almost no consequence here whether the microparticles are applied to the roll or to the extrudate.

1. A sheet extrudate with at least one surface which has self-cleaning properties,
wherein
a synthetic polymer surface of the sheet extrudate (X) has at least one securely anchored layer of microparticles (P) which have hydrophobic properties and have from primary particles combined to give agglomerates or aggregates whose size is from 0.2 to 100 μm, which form elevations having an average height of from 20 nm to 25 μm and an average separation of from 20 nm to 25 μm, where the microparticles (P) have been directly anchored within the synthetic polymer surface (X) and have not been linked via a carrier material.

2. The sheet extrudate as claimed in claim 1,
wherein
the elevations have an average height of from 50 nm to 4 μm and/or an average separation of from 50 nm to 4 μm.

3. The sheet extrudate as claimed in claim 1,
wherein
the microparticles have been selected from particles of silicates, minerals, metal oxides, metal powders, silicas, pigments, or polymers.

4. The sheet extrudate as claimed in claim 1,
wherein
the microparticles have been selected from particles of fumed silicas, precipitated silicas, aluminum oxide, mixed oxides, doped silicates, titanium dioxides, or pulverulent polymers.

5. The sheet extrudate as claimed in claim 4,
wherein
the microparticles are hydrophobicized fumed silicas.

6. The sheet extrudate as claimed in claim 1,
wherein
the sheet extrudate itself comprises a material selected from polycarbonates, polyoxymethylenes, polyacrylates, polymethacrylates, polyamides, polyvinyl chloride, polyethylenes, polypropylenes, aliphatic linear or branched polyalkenes, cyclic polyalkenes, polystyrenes, polyesters, polyacrylonitrile, polyalkylene terephthalates, and polyvinylidene fluoride, or comprises other polymers from polyisobutene, poly-4-methyl-1-pentene, and polynorbornene, in the form of homo- or copolymer, or else comprises a mixture of these.

7. The sheet extrudate as claimed in claim 1,
wherein
the microparticles have been anchored with from 10 to 90% of their average particle diameter within the surface.

8. A process for producing sheet extrudates as claimed in claim 1, with at least one surface which has self-cleaning properties and has elevations formed by microparticles,
which comprises
impressing microparticles which have hydrophobic properties and have combined from primary particles to give agglomerates or aggregates whose size is from 0.2 to 100 μm, by means of a roll, into the surface of the melt of a sheet extrudate, where this melt has not yet solidified, and where more than 50% of the microparticles are impressed only to the extent of 90% of their diameter into the surface of the sheet extrudate.

9. The process as claimed in claim 8,
wherein
the sheet extrudate comprises a polymer based on polycarbonates, on polyoxymethylenes, on polyacrylates, on polymethacrylates, on polyamides, on polyvinyl chloride, on polyethylenes, on polypropylenes, on aliphatic linear or branched polyalkenes, on cyclic polyalkenes, on polystyrenes, on polyesters, on polyacrylonitrile, or on polyalkylene terephthalates, or on polyvinylidene fluoride, or comprises other polymers from polyisobutene, poly-4-methyl-1-pentene, and polynorbornene, in the form of homo- or copolymer, or else comprises a mixture of these.

10. The process as claimed in claim 8,
wherein
the microparticles are impressed into the surface of the sheet extrudate by means of a roll for smoothing the sheet extrudate.

11. The process as claimed in claim 8,
wherein,
prior to impression into the sheet extrudate, the microparticles are applied to the surface of the roll used to impress the microparticles.

12. The process as claimed in claim 11,
wherein
the microparticles are sprayed onto the roll.

13. The process as claimed in claim 8,
wherein
the roll has a temperature of from 20 to 150° C.

14. The process as claimed in claim 8,
wherein
use is made of at least two rolls, and hydrophobic microparticles are impressed into the surface of the sheet extrudate on two sides of the sheet extrudate.

15. The process as claimed in claim 8,
wherein
use is made of microparticles selected from silicates, minerals, metal oxides, metal powders, silicas, pigments, or polymers.

16. The process as claimed in claim 15,
wherein
microparticles composed of hydrophobicized fumed silicas are used.

17. A film with a surface which has self-cleaning properties and has surface structures with elevations, produced by the process of claim 8.

18. A sheet with a surface which has self-cleaning properties and has surface structures with elevations, produced by the process of claim 8.

19. The sheet extrudate as claimed in claim 2,
wherein
the microparticles have been selected from particles of silicates, minerals, metal oxides, metal powders, silicas, pigments, or polymers.

20. The sheet extrudate as claimed in claim 2,
wherein
the microparticles have been selected from particles of fumed silicas, precipitated silicas, aluminum oxide, mixed oxides, doped silicates, titanium dioxides, or pulverulent polymers.
